(19) United States
(12) Patent Application Publication
(10) Pub. No.: US 2026/0274165 A1
(43) Pub. Date: Sep. 17, 2026

(54) Device and Method for Identifying and Displaying a Region, Observed by a Vehicle Driver, in the Interior of a Vehicle

(71) Applicant: Bayerische Motoren Werke Aktiengesellschaft, Muenchen (DE)

(72) Inventors: Thomas Ewender, Bad Aibling (DE); Johannes Feldmaier, Ebersberg (DE); Simone Camberg, Muenchen (DE)

(21) Appl. No.: 19/162,391

(22) PCT Filed: Oct. 9, 2023
(86) PCT No.: PCT/EP2023/077839

§ 371 Date: Sep. 4, 2025

(30) Foreign Application Priority Data
Mar. 13, 2023 (DE) 10 2023 106 108.9

(51) Int. Cl. B60R 1/29; B60R 1/04; B60R 1/12

(52) U.S. Cl. CPC B60R 1/29; B60R 1/04; B60R 1/12; B60R 2001/1253; B60R 2300/307; B60R 2300/70

(57) ABSTRACT

A device determines and displays a region, observed by a vehicle driver, in a vehicle interior. The device includes a rearview mirror in the vehicle interior, at least one camera, and a processing unit. The camera captures at least one image having a depiction of a region of the interior and generates image data corresponding to the image. The processing unit processes the image data, detects an adjustment of the rearview mirror, and determines the region of the interior visible for the vehicle driver in the rearview mirror after the adjustment of the rearview mirror and to detect at least one object present in the region. The processing unit also outputs an image of at least one part having the at least one object of the region of the interior visible for the rearview mirror after the adjustment as an observed region on a display unit of the vehicle.

The present application is the U.S. national phase of PCT Application PCT/EP2023/077839 filed on Oct. 9, 2023, which claims priority of German patent application No. 10 2023 106 108.9 filed on Feb. 24, 2023, the entire contents of which are incorporated herein by reference.

### TECHNICAL FIELD

The disclosure relates generally to vehicles, and more particularly, to identifying and displaying a region, observed by a vehicle driver, in the interior of a vehicle.

### BACKGROUND

Document US 2022/0254132 A1 discloses a vehicle occupant monitoring system which comprises a camera attached to an interior rearview mirror of a vehicle. The camera contains an image sensor and an objective. The vehicle occupant monitoring system detects the presence of an occupant of the vehicle.

Document EP 3 040 809 A1 discloses a method and a system for controlling a human-machine interface, arranged in a vehicle, having at least two displays. The viewing direction of a vehicle driver is monitored. Based on the monitoring, it is determined which of the at least two displays the viewing direction of the vehicle driver is closest to.

Document EP 1 298 013 A2 discloses a monitoring device for a passenger compartment, which ensures the required monitoring region and can be installed both in right-hand drive vehicles and in left-hand drive vehicles. The monitoring device has a rearview mirror arranged in the interior of the vehicle and multiple imaging devices arranged in the rearview mirror. Each f the imaging devices is arranged in the rearview mirror at a predetermined angle in order to monitor a predetermined region in the passenger compartment.

The online lexicon Wikipedia discloses under the keyword “rearview mirror” that there are interior mirrors for high-end vehicle equipment which measure the current alignment via motor and/or sensor combinations and can reestablish stored positions, for example, depending on a memory function or vehicle key. Furthermore, if a rear-facing infant carrier is used on the car rear seat, the face of the child can be observed via the interior mirror in combination with an infant carrier mirror.

Furthermore, camera-based seat occupancy recognition functions are known in vehicles, by way of which it is possible to distinguish between “empty seat” “child in child seat”, and “adult person” (greater than or equal to the fifth percentile woman) and perform a corresponding classification.

In practice, it occurs that a vehicle driver wishes to observe a region in the interior of the vehicle. For this purpose, he can adjust the interior rearview mirror of the vehicle so that he can view and therefore observe the desired region of the interior in the interior rearview mirror. The actual function of the interior rearview mirror, being able to observe the region behind the vehicle through the rear window of the vehicle, is no longer ideally ensured due to the adjustment of the interior rearview mirror.

Proceeding from the known prior art, there is a need to specify a device and a method for identifying and displaying a region, observed by a vehicle driver, in the interior of a vehicle, which enables a simple definition of a region of the interior to be displayed on a display unit of the vehicle.

### SUMMARY

The above-described need, as well as others, are addressed by at least some embodiments described herein.

At least one embodiment of a device and a method according to the disclosure each achieve that the vehicle driver can observe a region in the interior of the vehicle, which is specified by an adjustment of the rearview mirror, on a display unit of the vehicle. In this way, it is not necessary to repeatedly look into the rearview mirror to observe the object. Rather, the vehicle driver and possibly also a front passenger can observe the object on the image displayed on the display unit. The rearview mirror is then no longer required to observe the object, so that the rearview mirror can be adjusted back or reset into a position in which the vehicle driver can observe a region behind the vehicle through the rear window of the vehicle.

Instead of a single image, multiple images in succession can also be output as an image sequence, in particular in the form of a video stream, on the display unit.

It can be particularly advantageous if the processing unit is designed to determine whether the vehicle driver adjusts the rearview mirror before or within a preset time after beginning a journey so that the region visible in the rearview mirror for the vehicle driver does not correctly comprise the region behind the vehicle and only then to determine the region of the interior visible for the vehicle driver in the rearview mirror after the adjustment and detect at least one object present in this region. The region behind the vehicle visible in the rearview mirror for the vehicle driver is then correct if the region behind the vehicle through the rear window is arranged centrally, in particular in the middle, in the region visible for the vehicle driver in the rearview mirror. This can be determined in particular with the aid of a camera connected to the rearview mirror or integrated in the rearview mirror. Alternatively or additionally, this can also be carried out by separate sensors in the interior mirror or by means of a camera, which is installed elsewhere in the interior and captures the mirror, for example, in a roof module of the vehicle. In this case, the images recorded by means of the camera could likewise be output on the display unit. The recognition of the adjustment of the rearview mirror can therefore also be established by means of multiple cameras. These cameras can be arranged, for example, in an instrument cluster, in the rearview mirror, in the roof module, in the vehicle roof lining, and/or in the A-pillar of the vehicle in order to detect views of the vehicle driver into the interior rearview mirror. These cameras can additionally or alternatively be used to capture the image which is to be displayed on the display unit. Alternatively or additionally, an image to be displayed can also be generated from the images captured by multiple cameras. The ideal setting of the mirror can be detected only by a camera in the rearview mirror or by a camera which can capture an image of the rearview mirror. For this purpose, the information about how the mirror is set and where the eye position of the driver is can be used to calculate or correct the ideal mirror setting from these two positions and possibly angles. In general, for example, the region visible for the vehicle driver in the rearview mirror can be determined by the field of view of the camera.

Furthermore, it can be particularly advantageous if the processing unit is designed to detect views of the vehicle driver in the rearview mirror proceeding from the image data and to check whether the duration of the views and/or the number of the views per unit of time each exceed a preset threshold value stored in a storage area of the processing unit, and if the processing unit is designed, proceeding from the image data of the camera, to output an image of at least a part comprising the at least one object of the region of the interior visible in the adjusted rearview mirror for the vehicle driver as the observed region on a display unit of the vehicle only when the threshold value or one of the threshold values or the threshold values are exceeded. In this way, the image of the object is only output on the display unit when the vehicle driver actually observes the region of the interior in which the object located. In particular, this is the case if the regular views of the vehicle driver into the rearview mirror take place more frequently than is typical in the corresponding traffic situation. The frequency of the regular views can be individually captured for different vehicle drivers and stored assigned to the respective vehicle driver. This can be in particular in a storage area of the processing unit or in a storage area assigned to the vehicle driver, in particular in a vehicle key or a software app, for example, on a smart phone of the vehicle driver or in a cloud memory assigned to the vehicle driver.

Furthermore, it can be advantageous if the processing unit is designed to determine, proceeding from a preset or via a human-machine interface, whether at least one part of the determined region is to be output or is still to be output on a display unit of the vehicle visible for the vehicle driver. In particular, the vehicle driver can be prompted via a corresponding output via an output unit (display unit and/or speech output unit) to define by a corresponding input whether the displayed region is still to be displayed. Alternatively, a proactive communication can be output that a video stream of the region visible in the rearview mirror is being output on the display unit and the image or the video stream is only displayed on the display unit in the case when the driver makes a corresponding input.

Furthermore, it can be advantageous if the processing unit is designed, upon a further adjustment of the rearview mirror, to still output the observed region originally shown in the output image on the display unit of the vehicle. In this way, the vehicle driver can still observe this region on the display unit and can use the rearview mirror again to observe the region behind the vehicle.

It can be advantageous if the camera is fixedly connected to the rearview mirror such that upon an adjustment of the rearview mirror, the camera and the rearview mirror are pivoted jointly. In this way, an adjustment of the rearview mirror can be easily detected by the changed field of view of the camera. A sensor installed in the camera, in particular a movement sensor, can also be used to detect the adjustment and/or a comparison with CAD data of the vehicle takes place and/or at least one special marker is provided in the interior of the vehicle and detected.

It can be particularly advantageous in this case if the processing unit is designed to detect the adjustment of the rearview mirror by way of a change of the image recorded by the camera. In this way, an adjustment of the rearview mirror can be detected easily by the changed field of view of the camera. In particular, the processing unit, starting from the image data of the images recorded with the aid of the camera, can detect a change of the optical axis of the camera and thus an adjustment of the rearview mirror.

It can also be advantageous if the processing unit is designed, upon a further adjustment of the rearview mirror, to change the image detail of the image recorded by the camera such that the object is still shown in the output image. If the camera is adjusted together with the rearview mirror, a further camera of the vehicle can capture the image shown on the display unit or the displayed image detail is tracked with the object such that the displayed image detail remains the same and therefore also the observed region remains the same. The further cameras can be positioned arbitrarily in the interior, in particular also to capture the second row of seats or the rear seat bench.

It can be particularly advantageous if the processing unit is designed to check whether the object detected in the region of the interior visible for the vehicle driver in the rearview mirror is an object of interest, and if the processing unit is designed, proceeding from the image data of the camera, to output an image of at least a part of the region of the interior visible in the rearview mirror which comprises the object of interest on the display unit of the vehicle. For this purpose, the processing unit can be designed to carry out a classification of an object located on the front passenger seat or in the back of in the baggage compartment and to determine a classification result. Potential objects of interest can be easily determined in this way.

The processing unit can be designed to output the image only if an object of interest has been detected, in particular classified. In this way, the image is only output if a high probability exists that the vehicle driver actually wishes to observe the region.

The object of interest can be at least one person in the back, a child in a child seat or in an infant carrier in the back or on the front passenger seat, an animal in the back or in the baggage region or on the front passenger seat with or without transport box. An empty front passenger seat, an empty child seat on the front passenger seat, an empty infant carrier on the front passenger seat, or an empty animal transport box are not objects of interest, for example. In this way, an object can be determined easily which is actually of interest for the vehicle driver or is of interest with a high probability. The object can also be classified more accurately, however. The processing unit can also evaluate an entry scenario such as: driver places child in the child seat, detecting door openings, and/or the activity of fastening the safety belt can be captured, in particular filmed. A belt signal of the applied safety belt can also be captured and evaluated.

It can also be advantageous if the processing unit is designed, proceeding from the image data, to carry out a classification and/or a sub-classification of the object and to output information dependent on the classification result or sub-classification result in addition to the image on the display unit. Such classification results are in particular “child in a forward-facing child seat on the front passenger seat”, “child in a rear-facing infant carrier on the front passenger seat”, “child in a forward-facing infant carrier on the front passenger seat, “child in a forward-facing child seat on a rear seat”, “child in a rear-facing infant carrier on a rear seat”, “child in a forward-facing infant carrier on a rear seat”, “animal transport box with animal on the front passenger seat”, “animal transport box with animal on a rear seat”, “animal transport box with animal in baggage compartment”, “adult human on front passenger seat”, and “adult human on a rear seat”, wherein preferably a “human up to 1 year old”, a “1 to 3 year old human”, a “3 to 6 year old human”, and/or a “6 to 10 year old human” and/or a “adult human” are classified as a sub-classification result. Alternatively or additionally, “child sleeps calmly” “child sleeps restlessly”, “child screams/cries”, “child is happy and calm”, “child is happy and restless”, “pet sleeps”, “pet moves happily and restlessly”, “pet is happy and calm”, can be determined and output as a sub-classification result.

Furthermore, it can be advantageous if the processing unit is designed, proceeding from the image data, to determine a viewing direction of the vehicle driver and proceeding from the determined viewing direction and a determined alignment of the rearview mirror, to determine the region visible for the vehicle driver in the rearview mirror. In this way, the region in the interior of the vehicle in which an object to be detected could be located can be determined easily. This region can then be determined in the image recorded by the camera. Proceeding from the image data of the determined region, the processing unit determines whether an object and/or an object of interest is located in this region and preferably classifies it.

Furthermore, it can be advantageous if the field of view of the camera has a capture angle in the range of 100° to 150°, wherein the camera is preferably a monocular camera and/or an RGB camera. In other embodiments, the camera can also be a stereo camera. In this way, a sufficiently large field of view of the camera is present in order to output the region with the object on the display unit even when the rearview mirror is reset again. It is also advantageous when multiple cameras are used, as was already mentioned above. The camera can additionally or alternatively be an IR-RGB camera or an IR camera, in order to also record images in the dark interior, for example, at night.

The method having the features of the other independent method claim has the same advantages as the claimed device. In particular, the method can be refined using the features of the dependent claims directed to the device.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a perspective schematic view of a cockpit of a vehicle;

FIG. 2 shows a schematic view of a first image of the interior of the vehicle recorded by the camera;

FIG. 3 shows a schematic view of a second image of the interior of the vehicle recorded by the camera;

FIG. 4 shows a schematic view of a third image of the interior of the vehicle recorded by the camera;

FIG. 5 shows a display unit of the vehicle having a depiction of a part of the first image of the interior recorded by the camera;

FIG. 6 shows the display unit of the vehicle having a depiction of a part of the second image of the interior recorded by the camera; and

FIG. 7 shows the display unit of the vehicle having a depiction of a part of the third image of the interior recorded by the camera.

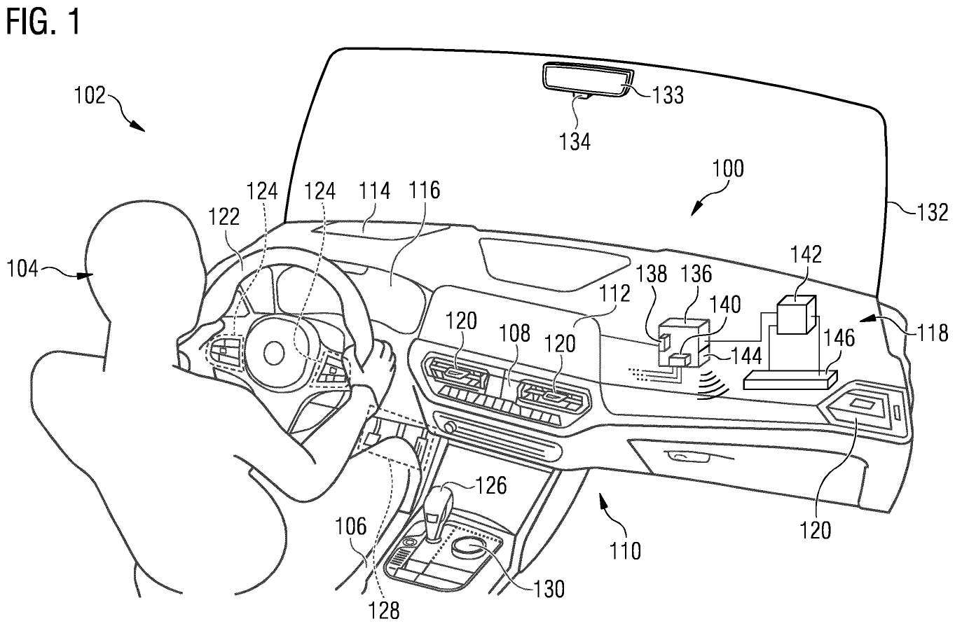

FIG. 1 shows a perspective schematic view of a cockpit 100 of a vehicle 102. A vehicle driver 104 is seated on a driver seat 106 of the vehicle 102. A display 108 for displaying information about deactivated front passenger airbag 146 of the vehicle 102 is arranged by way of example in the region of a center console 110 of the cockpit 100. The cockpit 100 moreover comprises a central information display (CID) 112, a head-up display 114, and a graphic instrument cluster 116, which are arranged in a dashboard 118 of the vehicle 102. The dashboard 118 furthermore comprises air outlet nozzles 120 of a climate control system of the vehicle 102. In FIG. 1, air outlet nozzles 120 are shown by way of example in the region of the center console 110 and on a front passenger side. The cockpit 100 furthermore comprises a steering wheel 122 having operating elements 124, a gear selection switch 126, a set of pedals 128, and an input unit 130 having a rotating wheel and a pushbutton function and/or a touch input field. This input unit 130 is also referred to as an ergo commander.

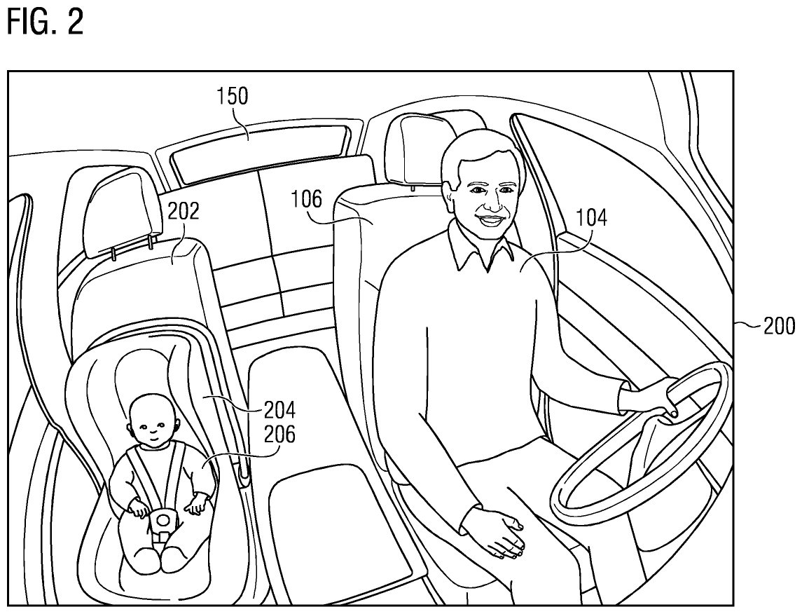

An interior rearview mirror 133 and a camera 134 integrated in this interior rearview mirror 133 are arranged in the upper region of a windshield 132 of the vehicle 102. Upon an adjustment of the rearview mirror 133, the optical axis of the camera 134 is pivoted. The camera 134 is designed and integrated into the rearview mirror 133 such that it captures images having a depiction of at least one region of the interior of the vehicle 102 in an adjustment range of the rearview mirror 133. Specifically, the field of view of the camera 134 is directed in the direction of the driver seat 106 and a front passenger seat 202 of the vehicle 102. Exemplary images 200, 300, 400 of the camera 134 are shown in FIGS. 2 to 4. The camera 134 is designed in particular to capture multiple chronologically successive images, in particular in the form of a video stream, to generate image data corresponding to the images 200, 300, 400, and to transmit these data to a control unit 136 used as a processing unit. The camera 134 has a field of view of 120°. In other embodiments, the camera 134 can also have a field of view in the range of 150° or more. The images 200, 300, 400 shown in FIGS. 2 to 4 have been recorded during various journeys of the vehicle 102.

The control unit 136 has data outputs 138 and data inputs 140, which are used for connection to further units of the vehicle 102, for example to further cameras, sensors, input and output units, and control units 142, 146 of assistance systems.

The control unit 136 furthermore comprises a communication module 144, which is designed to establish a connection to a telecommunication network, in particular a mobile wireless network.

The control unit 136 detects an adjustment of the interior rearview mirror 133 by way of the processing of the image data and then determines the region of the interior visible for the vehicle driver 104 in the rearview mirror 133 after the adjustment. Alternatively or additionally, the adjustment of the rearview mirror 133 can be determined by sensor signals, processed by the control unit, of corresponding position sensors of the rearview mirror 133.

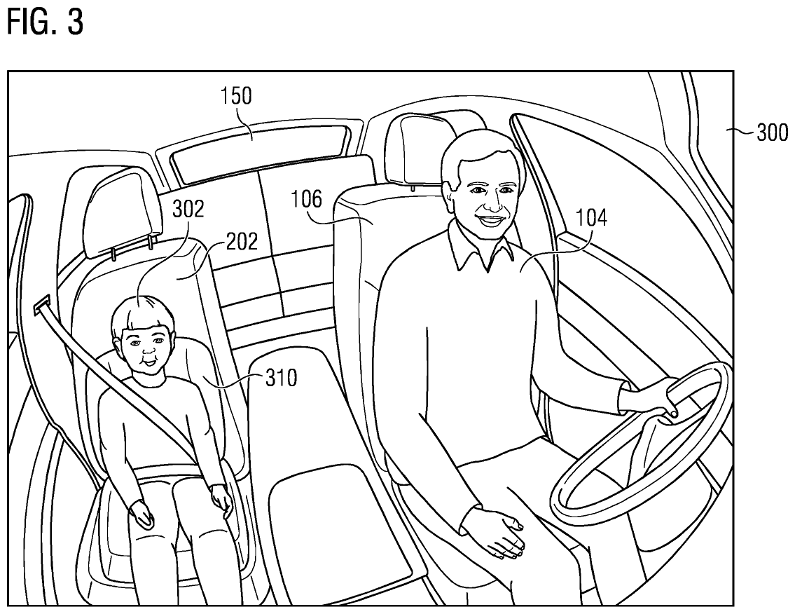

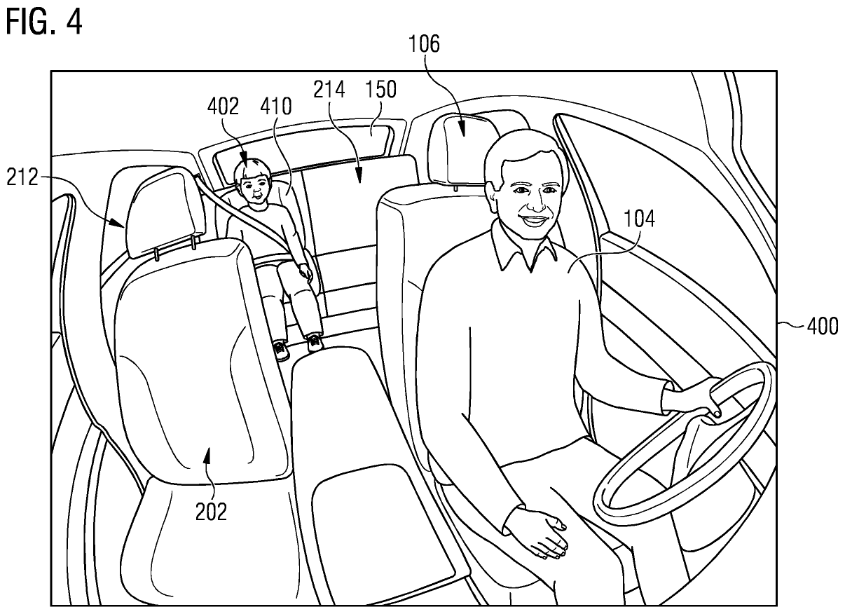

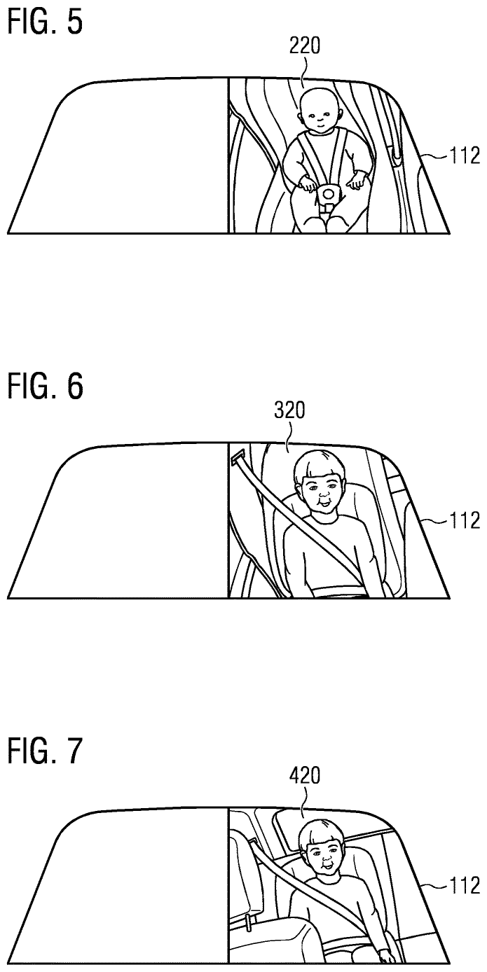

Proceeding from the image data, the control unit 136 determines an object present in the determined region. Proceeding from the image data of the camera 134, an image 220, 320, 420 (FIGS. 5 to 7) of at least a part comprising the at least one object of the region of the interior visible for the vehicle driver 104 in the adjusted rearview mirror 133 is output as the observed region on the information display 112 used as the display unit of the vehicle 102. In the driving situation according to FIG. 2, the object is an infant 206 in the infant carrier 204, in the driving situation according to FIG. 3, a child 302 in the child seat 310 on the front passenger seat 202, and in the driving situation according to FIG. 4, a child 402 in the child seat 410 on the rear seat bench 214.

The vehicle driver 104 can thus specify a region in the interior of the vehicle 102 by an adjustment of the rearview mirror 133 and observe it on the display unit 112 of the vehicle 102. It is thus not necessary to look repeatedly into the rearview mirror 133 to observe the object. Rather, the vehicle driver 104 and possibly also a front passenger can observe the object 206, 302, 402 on the image displayed on the display unit 112. The rearview mirror 133 is then no longer required to observe the object 206, 302, 402, so that the rearview mirror 133 can then be adjusted back or reset into a position in which the vehicle driver 104 can observe a region behind the vehicle 102 through the rear window 150 of the vehicle 102.

The camera 134 records an image sequence as a video stream, wherein a section 220, 320, 420 of the video image is then output on the display unit 112. An easy observation of the objects 206, 302, 402 is thus easily possible. Due to the selection of a suitable position of the display unit 112, the vehicle driver 104 no longer has to look away so much from the roadway in front of the vehicle 102 in order to observe the object 206, 302, 402. FIGS. 5 to 7 show the output unit 112, on which in each case a detail 220, 320, 420 of the image 200, 300, 400 of the interior, recorded by the camera 134, having the respective detected object 206, 302, 402 is output in the right half of the display unit 112. In the other half of the display unit 112, other information can be output, in particular the display of a navigation system of the vehicle or an interface for climate control function setting or an entertainment system.

The control unit 136 can determine proceeding from the image data whether the vehicle driver 104 adjusts the rearview mirror 133 before or within a preset time after beginning a journey so that the region visible for the vehicle driver 104 in the rearview mirror 133 does not correctly comprise the region behind the vehicle 102 and only then determine the region of the interior visible after the adjustment for the vehicle driver 104 in the rearview mirror 133 and detect at least one object 206, 302, 402 present in this region. The region behind the vehicle 102 visible for the vehicle driver 104 in the rearview mirror 133 is correct in particular if the region behind the vehicle 102 through the rear window 150 is arranged centrally, in particular in the middle, in the region visible for the vehicle driver 104 in the rearview mirror 133. For example, the region visible for the vehicle driver in the rearview mirror 133 can be determined proceeding from the field of view of the camera 134. The entire camera image 200, 300, 400 is shown in FIGS. 2 to 4. The region of the interior visible in the rearview mirror 133 or in the center of the rearview mirror 133 is smaller than the camera images 200, 300, 400 shown in FIGS. 2 to 4.

Proceeding from the image data of the camera 134, the control unit 136 detects views of the vehicle driver 104 into the rearview mirror 133 and checks whether the duration of the views and/or the number of the views per unit of time each exceed a preset threshold value stored in a storage area of the control unit 136. The image 220, 320, 420 of at least a part comprising the at least one object 206, 302, 402 of the region of the interior visible in the adjusted rearview mirror 133 for the vehicle driver 104 is only output as an observed region 220, 320, 420 on the display unit 112 when one of the threshold values is exceeded. In this way, in this embodiment the image 220, 320, 420 of the object 206, 302, 402 is only output on the display unit 112 if the vehicle driver 104 actually observes the region of the interior in which the object 206, 302, 402 is located. In particular, this is the case if the regular views of the vehicle driver 104 into the rearview mirror 133 take place more frequently than is typical in the corresponding traffic situation. The frequency of the regular views can be individually captured for different vehicle drivers 104 and stored assigned to the respective vehicle driver 104. This can in particular in a storage area of the control unit 136 or in a storage area assigned to the vehicle driver 104, in particular in a vehicle key or a software app of the smartphone of the vehicle driver 104 or in a cloud memory assigned to the vehicle driver 104.

Before the display of the observed region 220, 320, 420 on the display unit 112, the control unit 136 determines by a corresponding preset or via a communication with the vehicle driver 104 via a human-machine interface whether at least a part 220, 320, 420 of the determined region is to be output on the display unit 112 visible for the vehicle driver 104. If the observed region 220, 320, 420 is already output on the display unit 112 before this communication, it is determined via the human-machine interface whether at least a part 220, 320, 420 of the determined region is still to be output on the display unit 112. In particular, the vehicle driver 104 can be prompted via a corresponding output on the display unit 112 or a speech output unit to determine by a corresponding input whether the displayed region is still to be displayed.

Alternatively or additionally, a proactive message can be output on the display unit 112 or via the speech output unit that a video stream of a region visible in the rearview mirror 133 can be output on the display unit 112. The image or the video stream is only displayed on the display unit 112 in the case when the vehicle driver 104 makes a corresponding input.

Upon a further adjustment of the rearview mirror 133 by the vehicle driver 104, which is detected either via corresponding sensor signals of position sensors of the rearview mirror 133 or via the image 200, 300, 400 captured by the camera 134, an output of images of the observed region 220, 320, 420 originally shown in the output image continues to take place on the display unit 112. The vehicle driver 104 can thus continue to observe this region 220, 320, 420 on the display unit 112 and again use the rearview mirror 133 to observe the region behind the vehicle 102.

The adjustment of the rearview mirror 133 can be detected easily by the control unit 136 on the basis of the change of the image 200, 300, 400 recorded by the camera 134. This takes place in particular with the aid of the changed field of view of the camera 134. Proceeding from the image data of the images 200, 300, 400 recorded with the aid of the camera 134, a change of the optical axis of the camera 134 and thus an adjustment of the rearview mirror 133 can be detected for this purpose.

Upon a further adjustment of the rearview mirror 133, the control unit 136 changes the image detail of the image 200, 300, 400 recorded by the camera 134 such that the object 206, 302, 402 is still shown in the output image 220, 320, 420. When the camera 134 is adjusted together with the rearview mirror 133, a further camera of the vehicle 102 can also capture the image 220, 320, 420 shown on the display unit 112 or the image detail displayed is tracked with the object 206, 302, 402 such that the displayed image detail 220, 320, 420 remains the same and therefore the observed region also remains the same.

In an alternative embodiment, the control unit 136 additionally checks whether the object 206, 302, 402 detected in the region of the interior visible to the vehicle driver 104 in the rearview mirror 133 is an object of interest. If this is the case, proceeding from the image data of the camera 134, an image of at least a part 220, 320, 420 comprising the object of interest of the region of the interior visible in the rearview mirror 134 is output by the control unit 136 on the display unit 112. For this purpose, the control unit 136 can perform a classification of an object 206, 302, 402 located on the front passenger seat 202 or in the rear 214 or in the baggage compartment in order to determine a classification result. Potential objects of interest can be easily determined in this way.

The control unit 136 then preferably only outputs the image 220, 320, 420 on the display unit 112 when an object of interest has been detected, in particular classified. The image 220, 320, 420 is therefore only output when a high probability exists that the vehicle driver 104 actually wishes to observe the region.

The object of interest 206, 302, 402 can be a person in the rear, a child in a child seat or in an infant carrier in the rear or on the front passenger seat 202, an animal in the rear or in the baggage compartment or in the front passenger seat 202 with or without transport box. An empty front passenger seat 202, an empty child seat on the front passenger seat 202, an empty infant carrier on the front passenger seat 202, and an empty animal transport box are not objects of interest, for example. In this way, an object 206, 302, 402 can be determined easily which is actually of interest for the vehicle driver 104 or is of interest with a high probability. The object 206, 302, 402 can also be classified even more precisely, however. The control unit 136 can thus perform a classification and/or a sub-classification of the object 206, 302, 402 proceeding from the image data and output information dependent on the classification result or sub-classification result on the display unit 112 in addition to the image 220, 320, 420. Such classification results are in particular “child in a forward-facing child seat on the front passenger seat”, “child in a rear-facing infant carrier on the front passenger seat”, “child in a forward-facing infant carrier on the front passenger seat, “child in a forward-facing child seat on a rear seat”, “child in a rear-facing infant carrier on a rear seat”, “child in a forward-facing infant carrier on a rear seat”, “animal transport box with animal on the front passenger seat”, “animal transport box with animal on a rear seat”, “animal transport box with animal in baggage compartment”, “adult human on front passenger seat”, and “adult human on a rear seat”, wherein preferably a “human up to 1 year old”, a “1 to 3 year old human”, a “3 to 6 year old human”, and/or a “6 to 10 year old human” and/or a “adult human” are classified as a sub-classification result. Alternatively or additionally, “child sleeps calmly” “child sleeps restlessly”, “child is happy and calm”, “child is happy and restless” can be determined and output as a sub-classification result.

Furthermore, the control unit 136 can determine a viewing direction of the vehicle driver 104 proceeding from the image data. Proceeding from the determined viewing direction and a determined alignment of the rearview mirror 133, the control unit 136 can determine the region visible for the vehicle driver 104 in the rearview mirror 133. In this way, the region in the interior of the vehicle 102 in which an object 206, 302, 402 to be detected could be located can be determined easily. This region can then be determined in the image 200, 300, 400 recorded by the camera 134. Proceeding from the image data of the determined region, the control unit 136 then determines whether an object and/or an object of interest is located in this region and preferably classifies it as described above.

The control unit 136 can perform a human body pose estimation method to determine the classification result or the sub-classification result in order to determine a dimension of at least one limb of a person, in particular of a child 206, 302, 402 and the age of the child proceeding therefrom. Alternatively or additionally, the control unit 136 can also use a pattern recognition method and/or a machine learning method in order to determine the age of the child 206, 302, 402.

It is particularly advantageous if the camera 134 is an RGB-IR interior camera. The recorded images are used in combination with the seat sensor system, in particular a sensor mat, or alone for classification of an object 206, 302, 402 on the front passenger seat 202 and the rear seat bench 214.

FIG. 2 shows a schematic view of an image 200 of the interior of the vehicle 102 recorded by the camera 134. An infant carrier 204, in which an infant 206 is seated, is arranged on the front passenger seat 202 of the vehicle 102. In order to classify the infant 206 proceeding from the image data, the control unit 136 carries out the above-mentioned human body pose estimation method and for this purpose in particular determines the length of a limb of the infant 206. In addition, the infant carrier 204 can be classified.

FIG. 3 shows a schematic view of a further image 300 of the interior of the vehicle 102 recorded by the camera 134. In the situation shown in FIG. 3, a larger child 302 at the age of approximately 10 years is seated on the front passenger seat 202 of the vehicle 102. To determine the age of the child 302, the control unit 136 performs a human body pose estimation method and determines the length of at least one limb of the child 302. In other embodiments, the age of the child 302 can also be determined with the aid of another method. In addition, the child seat 310 can be classified.

FIG. 4 shows a schematic view of a further image 400 of the interior of the vehicle 102 recorded by the camera 134. In the situation shown in FIG. 4, a larger child 402 at the age of approximately 10 years is seated on the rear seat bench 214 or in the rear of the vehicle 102. To determine the age of the child 402, the control unit 136 performs a human body pose estimation method and determines the length of at least one limb of the child 402. In other embodiments, the age of the child 402 can also be determined with the aid of another method. In addition, the child seat 410 can be classified.

FIG. 5 shows the display unit 112 with a depiction 220 of a part of the first image 200 of the interior recorded by the camera 134. The depiction 220 shows the infant 206 as the object to be observed.

FIG. 6 shows the display unit 112 having a depiction 320 of a part of the second image 300 of the interior recorded by the camera 134. The depiction 320 shows the child 302 as the object to be observed.

FIG. 7 shows the display unit 112 having a depiction 420 of a part of the third image 400 of the interior recorded by the camera 134. The depiction 420 shows the child 402 as the object to be observed.

In the exemplary embodiments described on the basis of FIGS. 1 to 7, the camera 134 and the control unit 136 form a device for determining and displaying a region, observed by a vehicle driver 104, in the interior of a vehicle 102. Further elements and features shown in FIGS. 1 to 7 and mentioned in the preceding description can be part of this device. The control unit 136 is also referred to as a processing unit.

### LIST OF REFERENCE SIGNS

100 cockpit
102 vehicle
104 vehicle driver
106 driver seat
108 display
110 center console
112, 114, 116 display element
118 dashboard
120 air outlet nozzles
122 steering wheel
124 operating element
126 gear selection switch
128 set of pedals
130 input unit
132 windshield
133 interior rearview mirror
134 camera
136 control unit
138 data output
140 data input
142, 146 control unit
144 communication module
150 rear window
200, 300, 400 image
202 front passenger seat
204 infant carrier
206 infant
306, 406 small child
214 rear seat bench
310, 410 child seat
220, 320, 420 section, detail

1.-15. (canceled)

16. A device for determining and displaying a region, observed by a vehicle driver, in an interior of a vehicle, comprising:
a rearview mirror arranged in the interior of the vehicle,
at least one camera of the vehicle configured to capture at least one image having a depiction of a region of the interior and to generate image data corresponding to the image,
a processing unit configured to,
process the image data,
detect an adjustment of the rearview mirror,
determine the region of the interior visible for the vehicle driver in the rearview mirror after the adjustment of the rearview mirror and to detect at least one object present in the region,
proceeding from the image data of the camera, output an image of at least one part comprising the at least one object of the region of the interior visible for the rearview mirror after the adjustment as an observed region on a display unit of the vehicle.

17. The device according to claim 16, wherein the processing unit is further configured to:
detect views of the vehicle driver into the rearview mirror proceeding from the image data and check whether a duration of the views or a number of the views per unit of time each exceeds a preset threshold value stored in a storage area of the processing unit; and
proceeding from the image data of the camera, output an image of at least one part, comprising the at least one object, of the region of the interior visible for the vehicle driver in the adjusted rearview mirror as the observed region on the display unit of the vehicle only if the threshold value or one of the threshold values or the threshold values are exceeded.

18. The device according to claim 16, wherein the processing unit is further configured to:
determine, proceeding from a preset or via a human-machine interface, whether at least one part of the determined region is to be output or is to remain outputted on the display unit of the vehicle visible for the vehicle driver.

19. The device according to claim 16, wherein the processing unit is further configured to:
responsive to a further adjustment of the rearview mirror, continue to output the observed region shown in the output image on the display unit of the vehicle.

20. The device according to claim 16, wherein the processing unit is further configured to:
after an image of the observed region is output on the display unit, to output a notification to the vehicle driver that the rearview mirror can be set correctly again.

21. The device according to claim 16, wherein the processing unit is further configured to:
after an image of the observed region is output on the display unit, to output a signal to an automatically settable mirror for a correct setting of the rearview mirror.

22. The device according to claim 16, wherein the camera is fixedly connected to the rearview mirror such that upon an adjustment of the rearview mirror, the camera and the rearview mirror are jointly adjusted.

23. The device according to claim 22, wherein the processing unit is further configured to detect the adjustment of the rearview mirror by way of a change of the image recorded by the camera.

24. The device according to claim 23, wherein the processing unit is further configured to:
responsive to a further adjustment of the rearview mirror, to change an image detail of the image recorded by the camera such that the object is still shown in the output image.

25. The device according to claim 22, wherein the processing unit is further configured to:
responsive to a further adjustment of the rearview mirror, to change an image detail of the image recorded by the camera such that the object is still shown in the output image.

26. The device according to claim 16, wherein the processing unit is further configured to:
determine whether the object detected in the region of the interior visible for the vehicle driver in the rearview mirror is an object of interest;
proceeding from the image data of the camera, output an image of at least a part comprising the object of interest of the region of the interior visible in the rearview mirror on the display unit of the vehicle.

27. The device according to claim 26, wherein the processing unit is further configured to:
output the image only when an object of interest has been detected.

28. The device according to claim 27, wherein the determined object of interest is a person in a rear, a child in a child seat or an infant in an infant carrier in the rear or on a front passenger seat, an animal in the rear or in a baggage region or on the front passenger seat with or without a transport box.

29. The device according to claim 16, wherein the processing unit is further configured to:
proceeding from the image data, perform a classification of the object; and
output information dependent on the classification in addition to the image on the display unit.

30. The device according to claim 16, wherein the processing unit is further configured to:
determine a viewing direction of the vehicle driver proceeding from the image data; and
determine the region visible for the vehicle driver in the rearview mirror proceeding from the determined viewing direction and a determined alignment of the rearview mirror.

31. The device according to claim 16, wherein a field of view of the camera has a capture angle in a range of 100° to 150°.

32. The device according to claim 31, wherein the camera is one or more selected from the group consisting of a monocular camera, an RGB camera, and an IR camera.

33. A method for determining and displaying a region, observed by a vehicle driver, in an interior of a vehicle, the method comprising:
capturing at least one image having a depiction of a region of the interior of the vehicle using at least one camera of the vehicle and generating image data corresponding to the image;
processing, using a processing unit, the image data, detecting, using the processing unit, an adjustment of a rearview mirror arranged in the interior of the vehicle;
determining, using the processing unit, the region of the interior visible for the vehicle driver in the rearview mirror after the adjustment is detected and at least one object present in this region is detected, and
proceeding from the image data of the camera, outputting, using the processing unit, an image of at least one part, comprising the at least one object, of the region of the interior visible for the vehicle driver in the rearview mirror after the adjustment as the observed region on a display unit of the vehicle.
